(19) United States
(12) Patent Application Publication
(10) Pub. No.: US 2019/0147398 A1
(43) Pub. Date: May 16, 2019

(54) CONTAINER TRACKING SYSTEMS AND METHODS

(71) Applicant: WISETECH GLOBAL LIMITED, Alexandria, New South Wales (AU)

(72) Inventors: Richard White, Alexandria, New South Wales (AU); Angela Gadaev, Alexandria, New South Wales (AU); Igor Nuzhnov, Alexandria, New South Wales (AU); Ilya Kirsanov-Belov, Alexandria, New South Wales (AU); Dmytro Boiko, Alexandria, New South Wales (AU)

(21) Appl. No.: 16/306,577

(22) PCT Filed: Jun. 2, 2017
(86) PCT No.: PCT/AU2017/050536

§ 371 Date: Dec. 2, 2018

(30) Foreign Application Priority Data
Jun. 2, 2016 (AU) 2016902127

(51) Int. Cl. G06Q 10/08; G06Q 50/28

(52) U.S. Cl. CPC G06Q 10/0833; G06Q 50/28; G06Q 10/0838

(57) ABSTRACT

This disclosure relates to a container tracking system for communicating container tracking data over a data network. The data network comprises the container tracking system, a container carrier computer system, a first freight forwarder computer and a second freight forwarder computer, the container tracking system comprises a database server, an input port to receive electronic tracking request data and to receive container tracking data from a container carrier computer. The system further comprises an output port to send container tracking data. There is also a processor to repeatedly receive tracking requests, send the requests to a container carrier computer system, and receive responses to create multiple records in a database of the container tracking system comprising multiple shipment identifiers associated with multiple container identifiers and associated with further container tracking data. The system can then receive further requests, query the database and send a selected record as a response.

### CROSS-REFERENCE TO RELATED APPLICATIONS

The present application claims priority from Australian Provisional Patent Application No 2016902127 filed on 2 Jun. 2016, the content of which is incorporated herein by reference.

### TECHNICAL FIELD

This disclosure relates to computer systems and methods that facilitate the tracking of containers.

### BACKGROUND

A logistics service provider is a company that manages the flow of goods between points of origin and destination. Supply chain stakeholder is another term for logistics service provider. The supply chain may start with an exporter handling cargo to freight forwarder, who processes the goods onto a warehouse, delivers them to a container terminal for further delivery by an ocean carrier to the port of destination, and so on.

Freight forwarders are entities that handle the transport of goods for their customers. This can include transport of the goods from a freight forwarder's customer's location to another location and the distribution of goods from the location to a final destination. A transit point is a point along the supply chain where consignment handling is passed from one supply chain stakeholder to another. FIG. 1 illustrates a transport chain from a warehouse waiting for full pick up at the beginning of the export process to the return of an empty container to a container yard at the end of the import process.

To better utilize allocated space and optimize costs, the freight forwarders may consolidate a number of individual customer shipments to a single master shipment. The commingling of shipments increases the difficulty of knowledge of the whereabouts of a shipment since not all of the items within the shipment travelled the same path. That is, shipments may be split up so that they travel in different containers aboard carrier ships.

A process, method or system described herein may be explained with reference to modules. A module is part of a more complex structure. A module can be an independent unit of a dependent unit. A module can be individually developed and later linked to the more complex structure.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or step.

### SUMMARY

When a freight forwarder, for example, via a computer system processes freight for travel, it may receive certain acknowledgements from a carrier relating to the booking including some but not all tracking information. Additionally, critical tracking information is not readily available to supply chain stakeholders who are not dealing with carriers directly, such as smaller freight forwarders, customs brokers, packing facilities, warehouses, land transport companies etc. This information is however critical for various supply chain stakeholders in order to prepare for timely processing of cargo, plan for possible delays and avoid penalties for late cargo or container handling.

Shipment tracking is of high interest to the freight forwarder, in particular container tracking. For example, without knowing the whereabouts of a container, plans for customs, plans for pick up/retrieval, plans for delivery cannot be satisfactorily made. Additionally penalties may apply for late container returns, trucks queuing up at the terminal gates etc. It would be beneficial to the freight forwards, their customers and suppliers to be apprised of the whereabouts of a container holding their goods.

To determine the whereabouts of a container, a freight forwarder is required to individually query a carrier web site or by a phone call or an email, or check with other supply chain stakeholders the location of a container. Such is time consuming and error prone. It would be much more efficient were a freight forwarder able to automatically receive the container tracking information, without the research, in particular when the freight forwarder is not yet in possession of the container number (this happens, for example, when a carrier releases an empty container of a requested quality to a freight forwarder for packing, but this could be any first available container in the container yard of the above quality. A forwarder then needs to check either with the carrier or an empty container park or a transport company or a packing facility to get the correct container number, key it manually into the system so that it can be correctly managed by the forwarder and tracked for each of their customers and suppliers (this becomes especially difficult for consolidated cargo).

There is provided a container tracking system for communicating container tracking data over a data network. The data network comprises the container tracking system, a container carrier computer system, a first freight forwarder computer and a second freight forwarder computer. The container tracking system includes a database server, an input port to receive electronic tracking request data from the first freight forwarder computer system and the second freight forwarder computer system and to receive container tracking data from a container carrier computer, an output port to send container tracking data to the first freight forwarder computer system and the second freight forwarder computer system. The network further includes a processor configured to receive from the first freight forwarder computer system via the input port first electronic tracking request data for container data stored at the carrier computer, the first electronic tracking request data being representative of a first shipment identifier being of a shipment identifier type that is different to a container identifier type, send the first electronic tracking request data to the container carrier computer system, receive from the container carrier computer system via the input port first response data, the first response data being indicative of a first container identifier being of a container identifier type and first container tracking data, generate a record in a database of the container tracking system comprising the first shipment identifier associated with the first container identifier and associated with the first container tracking data and then repeat the previous steps to create multiple records in the database of the container tracking system comprising multiple shipment identifiers associated with multiple container identifiers and associated with further container tracking data, and receive from the second freight forwarder computer system via the input port second electronic tracking request data, the second electronic tracking request data being representative of a second container identifier or a second shipment identifier, query the database to retrieve a selected record by matching the second container identifier against the multiple container identifiers in the database or by matching the second shipment identifier against the multiple shipment identifiers in the database, wherein the second electronic tracking request data remains outside the container carrier computer system and send via the output port the selected record as a response to the second electronic tracking request data to the second freight forwarder computer system.

Because freight forwarders and also customs brokers, packing facilities, land transport providers etc. individually query a carrier computer for container numbers and container data, not only is there is substantial traffic to the container carrier computer, the process is inefficient. Constant queries to the container carrier computer results in communication overhead and latency delays due to sending additional messages to the container carrier computer. Freight forwarders make online queries repeatedly until container numbers are available, which utilises resources that could be better spent.

It is an advantage that by keeping the second electronic tracking request data outside the container carrier computer, the disclosed container tracking systems and methods provides a response to the query directly based on a local database. That is, in accordance with the disclosed methods and systems, a freight forwarder may not be possession of a container number since the shipment identifier type is different to the container identifier type. Furthermore, container identifiers that have not necessarily been provided by the first freight forwarder are stored at the container tracking system and are then used to respond to the second query from the second freight forwarder.

To send the first electronic tracking request data may comprise to generate a database query to determine a carrier computer system that offers access to container tracking data based on the received shipment identifier type to send the electronic data request message to the determined container carrier computer system. The first response data may be indicative of multiple container identifiers associated with the first shipment identifier and the processor may be configured to generate a record in the database for each of the multiple container identifiers.

The processor may be further configured to receive tracking data via various data feeds, cull the tracking data for the multiple container identifiers, associate the multiple container identifiers with the shipment identifiers to continuously create or update records in the database to store the continuous container tracking data, transmit the updated records to the first freight forwarder computer system and second freight forwarder computer system. The second shipment identifier may be of a different shipment identifier type to the first shipment identifier type.

A processor of the disclosed systems may be further configured to generate a user interface to be displayed at the first freight forwarder computer system and second freight forwarder computer system, and to perform the steps of receive the first electronic tracking request data, and receive the second electronic tracking request data and send the selected record through the user interface.

There is provided a disclosed method for communicating container tracking data over a data network, the data network comprising a container tracking system, a container carrier computer system, a first freight forwarder computer and a second freight forwarder computer, the method including receiving from the first freight forwarder computer system via an input port first electronic tracking request data for container data stored at the carrier computer, the first electronic tracking request data being representative of a first shipment identifier being of a shipment identifier type that is different to a container identifier type, sending the first electronic tracking request data to the container carrier computer system, receiving from the container carrier computer system via the input port first response data, the first response data being indicative of a first container identifier being of a container identifier type and first container tracking data, creating a record in a database of the container tracking system comprising the first shipment identifier associated with the first container identifier and associated with the first container tracking data, repeating steps to create multiple records in the database of the container tracking system comprising multiple shipment identifiers associated with multiple container identifiers and associated with further container tracking data, receiving from the second freight forwarder computer system via the input port second electronic tracking request data, the second electronic tracking request data being representative of a second container identifier or a second shipment identifier, querying the database to retrieve a selected record by matching the second container identifier against the multiple container identifiers in the database or by matching the second shipment identifier against the multiple shipment identifiers in the database, wherein the second electronic tracking request data remains outside the container carrier computer system and sending via an output port the selected record as a response to the second electronic tracking request data to the second freight forwarder computer system. Software, when executed by a computer, causes the computer to perform the above method.

A disclosed container tracking computer system includes an input port to receive from a freight forwarder computer system electronic tracking request data representative of a shipment identifier being of a shipment identifier type that is different to a container identifier type including a database server, one or more computer processors configured to receive through the input port the shipment identifier being of the shipment identifier type, to create an electronic data request message for container tracking data comprising the shipment identifier, to send the electronic data request message to carrier computer system, to receive from the carrier computer system a data response message comprising container tracking data indicative of multiple containers associated with the shipment identifier and at least one container identifier associated with one of the multiple containers, to store the at least one container identifier on the database server associated with the shipment identifier and to send the container identifier and the container tracking data to the freight forwarder computer system.

The electronic tracking request data may be indicative of a first number of containers. The container tracking data may be indicative of a second number of containers. The computer processor may further be configured to compare the first number of containers to the second number of containers and create an alert if the first number of containers is different to the second number of containers.

The electronic tracking request data may be indicative of a first quality of containers. The container tracking data may be indicative of a second quality of containers. The computer processor may further be configured to compare the first quality of containers to the second quality of containers and create an alert if the first quality of containers is different to the second quality of containers.

The disclosed one or more processors may further be configured to send to the carrier computer system a feed command to cause the carrier computer system to continuously send container tracking data to the container tracking system, to receive continuous container tracking data from the carrier computer system, the continuous container tracking data being indicative of multiple container identifiers associated with the shipment identifier, to determine which of the multiple container identifiers are missing on the database server and to store the container tracking data and the multiple container identifiers that are missing on the database server associated with the shipment identifier.

The container tracking data may be indicative of a number of containers. The computer processor may further be configured to initialise a counter with the number of containers and decrement the counter each time the processor receives a container identifier that is missing from the database. Thus, the freight forwarder determines when all containers are accounted for without querying the container carrier computer.

The disclosed method for container tracking can include receiving through an input port a shipment identifier being of a shipment identifier type, creating an electronic data request message for container tracking data comprising the shipment identifier, sending the electronic data request message to a carrier computer system. Also included is receiving from the carrier computer system a data response message comprising container tracking data indicative of multiple containers associated with the shipment identifier and at least one container identifier associated with one of the multiple containers, storing the at least one container identifier on the database server associated with the shipment identifier and

sending the container identifier and the container tracking data to the freight forwarder computer system. Software, when executed by a computer, causes the computer to perform the above method.

Also disclosed is a container tracking computer system including an input port to receive from a freight forwarder computer system electronic tracking request data representative of a shipment identifier being of a shipment identifier type that is different to a container identifier type. Further disclosed is a computer processor configured to receive through the input port the shipment identifier being of the shipment identifier type, to send to the carrier computer system a feed command to cause the carrier computer system to continuously send container tracking data to the container tracking system, to receive continuous container tracking data from the carrier computer system, the continuous container tracking data being associated with the shipment identifier, to continuously store the continuous container tracking data on the database server, to receive further electronic tracking request data representative of the shipment identifier, to retrieve from the database server the continuous container tracking data and to send the continuous container tracking data retrieved from the database server to the freight forwarder computer system.

A disclosed includes method for container tracking includes receiving through an input port a shipment identifier being of a shipment identifier type, sending to the carrier computer system a feed command to cause the carrier computer system to continuously send container tracking data to the container tracking system, receiving continuous container tracking data from the carrier computer system, the continuous container tracking data being associated with the shipment identifier, continuously storing the continuous container tracking data on the database server, receiving further electronic tracking request data representative of the shipment identifier, retrieving from the database server the continuous container tracking data and sending the continuous container tracking data retrieved from the database server to the freight forwarder computer system.

A disclosed user interface for a logistics system includes a console displayed on a computer display and a background of the computer in which processes occur so that information is displayed on the console, the console including fields in which a book number or bill reference is displayed in a book number or bill reference field, the console configured so that it initially includes no container number in a container number field unless it is entered by the user, in the background, a process which determines a container number associated with the book number or bill reference, when the console is configured to retrieve the container number by an allowance of the container number on the console, the container number populating the container number field and when the container number populates the container number field, the console further showing location tracking of the container over time.

Also disclosed is in a method for logistics management, in a cargo container tracking system wherein a cargo container is delivered and received via a transit path and wherein the cargo container is received and delivered by a particular cargo carrier identifiable by a carrier code, the cargo carrier maintaining digital records of the cargo container of at least one of a carrier code with the carrier booking reference, a carrier code with a master bill reference, and a carrier code and a container number, the method including generating a first digital request for the whereabouts of a container wherein the first digital request for the whereabouts of a container is transmitted with four request fields, wherein at least two of them are populated, the four request fields including a carrier code field, the carrier booking reference field, master bill reference field, and a container number field having places for one or more containers. Also disclosed is determining whether the populated request fields of the first digital request match the digital records of the cargo carrier and if the populated request fields do match the digital records of the cargo carrier, receiving as per the first digital request, the container number and the location of the container, and if the container number was not part of the first digital request, associating the container number field of the first digital request with the delivered container number and storing the same, generating a second digital request wherein the second digital request does not include a populated container number field, determining whether the populated request fields of the second digital request match the digital records of the cargo carrier wherein if the populated request fields do not match the digital records of the cargo carrier, determining whether the populated request fields of the second digital request were previously presented in a previous digital request and if a previous digital request included at least one populated request field of the second digital request and a container number has been associated with the previous digital request, populating the container number field of the second digital request.

The method may further include transmitting the second digital request to the cargo carrier and receiving as per the second digital request, the location of the container. The method may further comprise: at a server, determining whether the container location based upon the container number is being tracked; if the container number is being tracked, deliver the container location in response to the second digital request. Optional features described of any aspect of method, computer readable medium or computer system, where appropriate, similarly apply to the other aspects also described here.

### BRIEF DESCRIPTION OF DRAWINGS

FIG. 1 illustrates a transport chain according to the prior art.

An example will now be described with reference to:

FIG. 2 illustrates a container tracking system.

FIG. 3a illustrates a method for communicating container tracking data over a data network.

FIG. 3b illustrates a dataflow corresponding to the method in FIG. 3.

FIG. 4 illustrates a user interface for a logistics system.

FIG. 5 illustrates a method for logistics management.

FIG. 6 illustrates a detailed control flow for container tracking.

### DESCRIPTION OF EMBODIMENTS

Disclosed are systems and methods to facilitate the tracking of containers without substantial traffic accessing a container carrier's database to obtain container identifiers. When a freight forwarder/client is not in possession of a container identifier but is in possession of one or more other shipment identifiers, the disclosed systems and methods generate at least one record in a database of the disclosed container tracking system with respect to a first shipment identifier which is associated with a first container identifier. The generated record may then be associated with a different freight forwarder/client wherein the different freight forwarder/client is not in possession of a container identifier but is in possession of one or more other shipment identifiers to associate the other shipment identifiers with the first container identifier. In this way, traffic to a carrier's database is limited and enabled are ongoing container data feeds to freight forwarders' computer systems.

With previous tracking systems, stakeholders need a container number in order to get container tracking information. While freight forwarders are identified as stake holders in this discussion, the system is not limited to freight forwarders and this description is intended to be applicable to any stake holders including customers of freight forwarders, and any other interested party. While the claims and following discussion refer to computer systems of freight forwarders, that designation is intended for clarity and not as a limiting feature or element.

The disclosed systems and methods can track containers by other shipment identifiers: booking number, bill number, container number (all with carrier code). For example, ocean carrier bookings in a freight forwarding system are registered without container numbers. A forwarder books a certain number of containers of certain type from ocean carriers. By querying a booking number from a carrier, and then associating the returned the one or more container numbers with booking details of other freight forwarders, the disclosed systems and methods can return actual container numbers back to freight forwarders together with events that define latest container event. Adding actual container number decreases booked container count. This method may include matching and updating a booking with container count by actual container numbers.

The disclosed container tracking system updates container numbers on bookings for users saving them the necessity to query the carrier manually by for example, manually searching their web sites and even telephone calls repeatedly until container numbers are available. Because freight forwarders individually query a carrier computer for container numbers and container data such as location of the container, not only is there is substantial traffic to the container carrier computer so that carrier's system is burdened, the process is inefficient, creating extra cost to the process. Constant queries to the container carrier computer results in communication overhead and latency delays due to sending additional messages to the container carrier computer.

The users of a larger logistics system register a booking with an ocean carrier and the disclosed tracking systems update the booking with actual container details for the users. The disclosed systems and methods may be embedded in a module, component or an integrated element of a larger software system. The larger system may provide the booking function.

A user can determine whether to track one or more containers utilising the disclosed methods and systems. The container carrier computer system sends the container tracking events back to the container tracking computer system. If query occurs by a booking number (i.e. when container numbers are not yet known), the container numbers received against this booking number will automatically be added to the booking (and any previous container counts managed accordingly) dramatically reducing data entry requirements and a chance of error manually entering container numbers. If a query included a container number, or if a container number was added to a booking after the query event was generated, the container numbers will be matched against those registered on the job, and statuses will be updated accordingly.

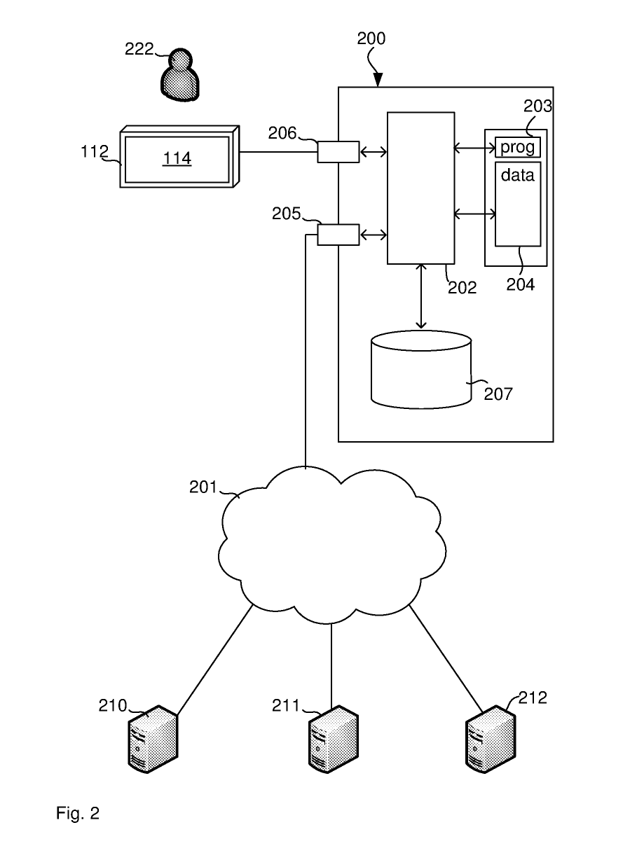

FIG. 2 illustrates a container tracking system 200 for communicating container tracking data over a data network 201, such as the Internet, LAN or public/private WAN. The computer system 200 comprises a processor 202 connected to a program memory 203, a data memory 204, a communication port 205 and a user port 206. The processor 202 is further connected to a database server 207, which may also be hosted on data memory 204. Besides the container tracking computer system 200, network 201 comprises a container carrier computer system 210, a first freight forwarder computer system 211 and a second freight forwarder computer system 212. While in most practical applications there would be multiple container carrier computer systems 210 for multiple carriers that can be queried on container movement and that can deliver event data, only one container carrier computer system 210 is shown for the sake of clarity. There may also be more than two freight forwarder computer systems and each of the freight forwarder computer system may provide a user interface that may be a remote device which may be considered different from a desk top type device, also referred to as consol or console. This interface is for the freight forwarder for seeking and receiving container movement and event data. Freight forwarder and client are used interchangeably.

It is noted that the container tracking system 200 may be a central server that provides a service, such as Software as a Service (Saas), to freight forwarders. In other examples, the container tracking system 200 is installed at the freight forwarder's premises and may be installed on a virtual server. In fact, the first freight forwarder computer system 211 or the second freight forwarder computer system 212 may share the same hardware with container tracking system 200, such as on two virtual machines on the same physical computer system. Processing may occur at any suitable location.

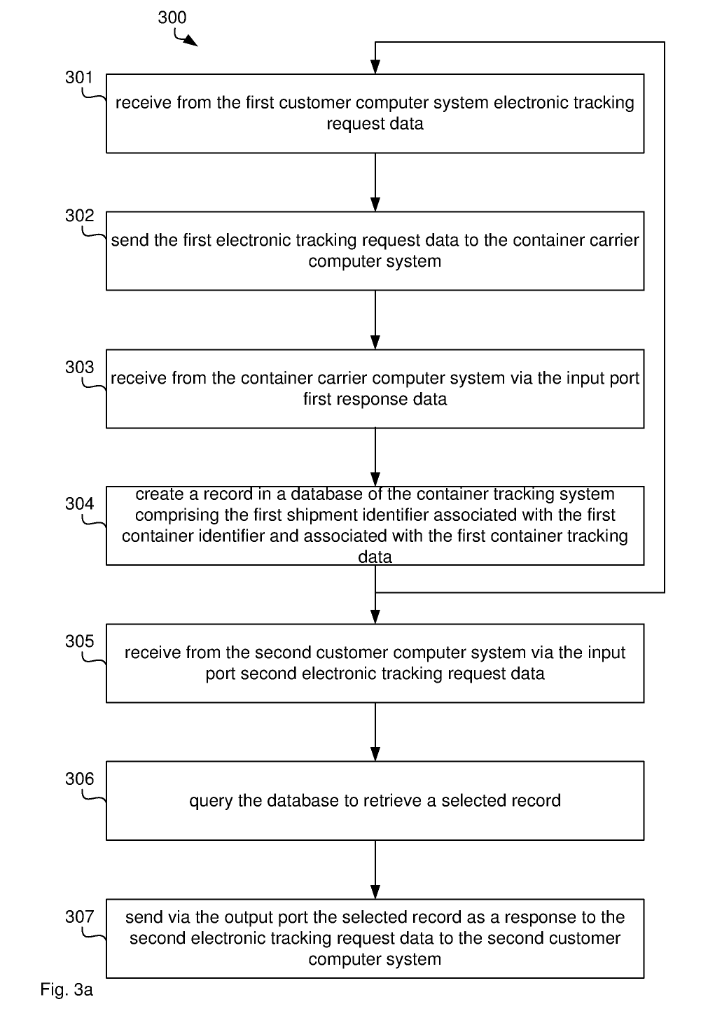

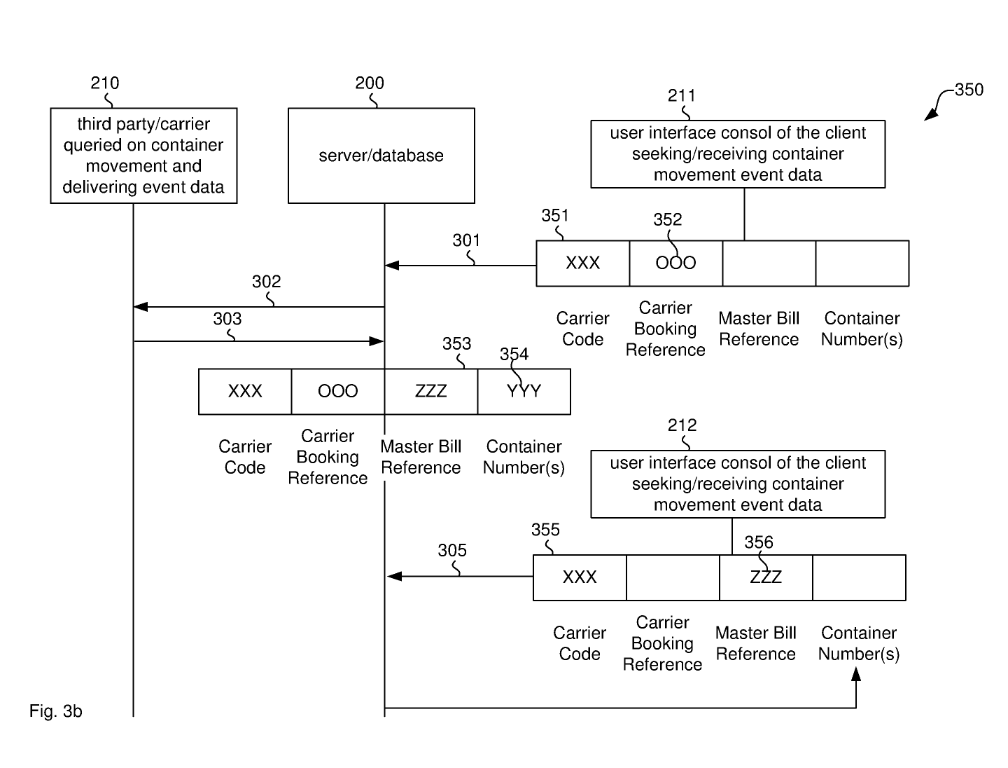

The program memory 203 is a non-transitory computer readable medium, such as a hard drive, a solid state disk or CD-ROM. Software, that is, an executable program stored on program memory 203 causes the processor 202 to perform the method in FIG. 3a. The term “determining a provider” refers to determining an identifier that is indicative of the provider. This also applies to related terms.

The processor 202 may receive data through communications port 205 such that communications port 205 functions as an input port to receive electronic tracking request data from the first freight forwarder computer system 211 and the second freight forwarder computer system 212 and to receive container tracking data from the container carrier computer 210. Communications port 205 may equally function as an output port to send container tracking data to the first freight forwarder computer system 211 and the second freight forwarder computer system 211. That is, the communications port 205 may be a single input/output port or may comprise separate ports for input and output, respectively.

Processor 202 may also receive container tracking data from data memory 204 and the user port 206, which is connected to a display 112 that shows a user interface 114 of a container tracking software application to a user 222. In one example, the processor 202 receives and processes the container tracking data in real time. This means that the processor 202 updates the records in database 207 every time container tracking data is received from the container carrier computer system 210 and completes this updating before the container carrier computer system 210 sends the next container tracking data update.

Although communications port 205 and user port 206 are shown as distinct entities, it is to be understood that any kind of data port may be used to receive data, such as a network connection, a memory interface, a pin of the chip package of processor 202, or logical ports, such as IP sockets or parameters of functions stored on program memory 203 and executed by processor 202. These parameters may be stored on data memory 204 and may be handled by-value or by-reference, that is, as a pointer, in the source code.

The processor 202 may receive data through all these interfaces, which includes memory access of volatile memory, such as cache or RAM, or non-volatile memory, such as an optical disk drive, hard disk drive, storage server or cloud storage. The computer system 200 may further be implemented within a cloud computing environment, such as a managed group of interconnected servers hosting a dynamic number of virtual machines.

It is to be understood that any receiving step may be preceded by the processor 202 determining or computing the data that is later received. For example, the processor 202 determines container tracking data, such as by pre-filtering, and stores the filtered container tracking data in data memory 204, such as RAM or a processor register. The processor 202 then requests the data from the data memory 204, such as by providing a read signal together with a memory address. The data memory 204 provides the data as a voltage signal on a physical bit line and the processor 202 receives the container tracking data via a memory interface.

It is to be understood that throughout this disclosure unless stated otherwise, nodes, edges, graphs, solutions, variables and the like refer to data structures, which are physically stored on data memory 204 or processed by processor 202. Further, for the sake of brevity when reference is made to particular variable names, such as “period of time” or “identifiers” this is to be understood to refer to values of variables stored as physical data in computer system 200.

FIG. 3a illustrates a method 300 as performed by processor 202 for communicating container tracking data over a data network. FIG. 3a is to be understood as a blueprint for the software program and may be implemented step-by-step, such that each step in FIG. 3a is represented by a function in a programming language, such as C++ or Java. The resulting source code is then compiled and stored as computer executable instructions on program memory 203, which means the processor 202 is configured to perform the steps of method 300. FIG. 3b illustrates a dataflow 350 corresponding to method 300 between container carrier computer system 210, container tracking computer system 210, first freight forwarder computer system 211 and second freight forwarder computer system 212.

It is noted that for most humans performing the method 300 manually, that is, without the help of a computer, would be practically impossible due to the sheer size of the data, the number of tables and the time in which the data is processed. Therefore, the use of a computer is part of the substance of the invention and allows performing the necessary calculations that would otherwise not be possible due to the large amount of data and the large number of calculations that are involved. The automatic ongoing data feed furthermore where once the containers identifiers are known would not be possible without the disclosed systems and methods as such container whereabouts are not necessarily delivered to freight forwarders without a query.

To commence method 300, processor 202 receives 301 from the first freight forwarder computer system 211 via the input port 205 first electronic tracking request data 351 for container data stored at the carrier computer 210. The first electronic tracking request data is representative of a first shipment identifier being of a shipment identifier type that is different to a container identifier type. This difference between the shipment identifier type and container identifier type often results from users of the service not being able to locate a container identifier or from the container identifier. In other cases, the container identifier may not have been assigned yet at the time the user received their shipment identifier.

In one example, the container identifier is a container number according to the container number type defined in ISO 6346 comprising a three letter owner code, a one letter category identifier, a six digit serial number and a check digit, for example, CSQ U 305438 3. The received shipment identifier may be a carrier booking reference 352, potentially combined with a carrier code, and/or a master bill reference.

Processor 202 then sends 302 the first electronic tracking request data to the container carrier computer system 210. It is noted that in some existing tracking solutions, requests without a container number are simply discarded or rejected. This leads to reduced freight forwarder satisfaction, increased traffic because requests are re-sent and reduced revenue in case of per-request billing. Since the container number is not included in the request, it is possible that some container carrier computer systems are not able to process the provided shipment identifier. In this case, container tracking system 200 comprises a database 207 that stores associations between container carriers and shipment identifier type offered by each container carrier. This way, processor 202 can query this database 207 to determine one of the container carriers that can process or that offers access to container tracking data based on the received shipment identifier type. Processor 202 then sends the first electronic tracking request data to the determined container carrier computer system.

In response to the tracking request, processor 202 receives 303 from the container carrier computer system 210 via the input port 205 first response data. The first response data is indicative of a first container identifier 354 being of a container identifier type and first container tracking data. In other words, container carrier computer system 210 sends a full data set that contains not only the provided shipment identifier but a range of further information. Typically, this information also includes the container identifier and the current location or status of the container.

With this information processor 202 can now generate or create 304 a record 353 in database 207 of the container tracking system 200. The record 353 comprises the first shipment identifier, such as the master bill reference, associated with the first container identifier, such as the container number 354. This new record 353 is further associated with the first container tracking data. For example, database 207 may comprise a table with headings “MasterBillReference”, “ContainerNumber”, “LatestStatus” and processor 202 adds a new record in this table including the received information. In other examples, the new record is distributed over multiple tables of database 207. For example, instead of storing the master bill reference explicitly, the new record contains a foreign key to a bill table and the latest status may be a foreign key of a status table. With any of these different options, the shipment identifier, container identifier and container tracking data are said to be associated in database 207, which generally means that any of the values, or at least a known shipment identifier, can be used in a query to retrieve the other (unknown) values, such as the container number.

In some cases, the shipment identifier, such as the master bill reference, is associated with multiple containers. For example, a freight forwarder wishes to ship goods that do not fit into one container but require multiple containers for shipment. However, there is only a single master bill reference for the entire shipment of the goods. As a result, when the shipment is allocated to the multiple containers, the master bill reference will eventually be associated with multiple container numbers. It is noted that the master bill reference is issued before the containers are assigned, so it is difficult for the freight forwarder to find out which container numbers or even how many containers are assigned to the master bill reference. However, when the container carrier computer system 210 receives a tracking request including a master bill reference, the response data is indicative of the multiple container numbers so far associated with the master bill reference. This means, processor 202 can generate or create a record in database 207 for each of the multiple container numbers that are all associated with the same master bill reference. It is noted, however, that the response data may have separate parts for each container and the container tracking data is different for each container. In other words, other than the fact that the response data for each container includes the same master bill reference, there is no difference to response data for multiple unrelated containers.

In one example, the electronic tracking request data received from first freight forwarder computer system 211 is indicative of a first number of containers and the container tracking data from the container carrier computer system 210 is indicative of a second number of containers. Processor 202 can then compare the first number of containers to the second number of containers and create an alert if the first number of containers is different to the second number of containers. This way, the freight forwarder can be alerted in cases where the freight forwarder's records do not correspond with the carrier's records. Similarly, the container tracking data may include quality of containers, such as 40 ft vs 20 ft and this type can also be compared to the freight forwarder's records and an alert can be created if the container qualities do not match.

Further, by repeatedly requesting tracking data from container tracking system 200, the freight forwarder can see how the individual container numbers become assigned to the master bill reference up until the total number of containers is equal to the number of assigned container numbers. In other words, over time, processor 202 receives new container numbers associated with the same master bill reference and determines which of the multiple container identifiers are missing in database 207. That is, processor 202 queries database 207 for a received container identifier and if the query returns no results, the container identifier is missing in database 207. If this is the case, processor 202 creates new records in database 207 to store the container tracking data and the missing container identifiers associated with the shipment identifier until the number of records with this master bill reference is equal to the number of containers and container numbers associated with this master bill reference.

Over time, processor receives further requests, sends further requests to container carrier computer systems and receives further response data. This way, processor 202 can create a large number of records in database 207, which can then be used to answer queries directly. In other words, processor 202 repeats 301, 302, 303 and 304 in FIG. 3 to create multiple records, such as between 10 and 10,000 records, in database 207 of the container tracking system 202. Similar to the record stored in the first iteration, the multiple records comprise multiple shipment identifiers associated with multiple container identifiers and associated with further container tracking data.

When processor 202 sends electronic tracking request data to the container carrier computer system 210, processor 202 may also send a request for a continuous data feed of container tracking data. Continuous in this context means that the container carrier computer system 210 sends or “pushes” data to the tracking system 200 without the tracking system 200 requesting it. For example, container carrier computer system 210 sends the container tracking data periodically, such as once a day, or every 15 minutes. The data feed of container tracking data from container carrier computer system 210 may contain container tracking data of one specific container and there may be a separate feed for each container. In another example, there is one single feed for all containers and the feed comprises the container tracking data for all containers for which tracking system 200 has requested an ongoing data feed. In yet another example, container carrier computer system 210 sends a complete dump of all available container tracking data for all containers handled by container carrier computer system 210.

In order to accurately process the data feed, processor 202 filters the data received via the various feeds and culls the tracking data for the multiple container identifiers. Culling in this context means that the processor 202 discards tracking data that is not associated with the container identifiers already in database 207. As a result, each time processor 202 receives tracking data through the data feed of the request for an ongoing data feed, processor 202 can update one, multiple or all records in database 207. This way, the status of containers in database 207 remains as up to date as possible and can be locally queried at any time.

After or during these repetitions of steps 301, 302, 303, 304 and the receiving of data feeds, processor 202 receives 305 from the second freight forwarder computer system 212 via the input port 205 second electronic tracking request data 355. The second electronic tracking request data 355 is representative of a second container identifier or a second shipment identifier. In the example of FIG. 3b, the second electronic tracking request data 355 is representative of a second shipment identifier that is of a different type to the shipment identifier 352 in the first electronic request data 352. In particular, while the first electronic request data 351 is indicative of a carrier booking reference 352, the second electronic tracking request data 355 is indicative of a master bill reference 356.

Now, the processor 202 has all the requested information available and up to date locally on database 207. Therefore, processor 202 queries 306 database 207 to retrieve a selected record. In FIG. 3b this is record 353. If a container identifier was received in the query, querying database 207 basically means matching the second container identifier against the multiple container identifiers in the database. If a shipment identifier was received (356 in FIG. 3b), querying database 207 means matching the second shipment identifier 356 against the multiple shipment identifiers in database 207. In any event, processor 202 can respond to the second electronic tracking request data based on the locally stored information, which means that the second electronic tracking request data remains outside the container carrier computer system 210. That is, processor 202 does not send the second electronic request data to the container carrier computer system 210. This means the traffic to the container carrier computer system 210 and the number of database queries at container carrier computer system 210 are reduced. This leads to faster response times, less points of failure and reduced cost. Finally, processor 202 sends 307 via the output port 205 the selected record as a response to the second electronic tracking request data to the second freight forwarder computer system 212.

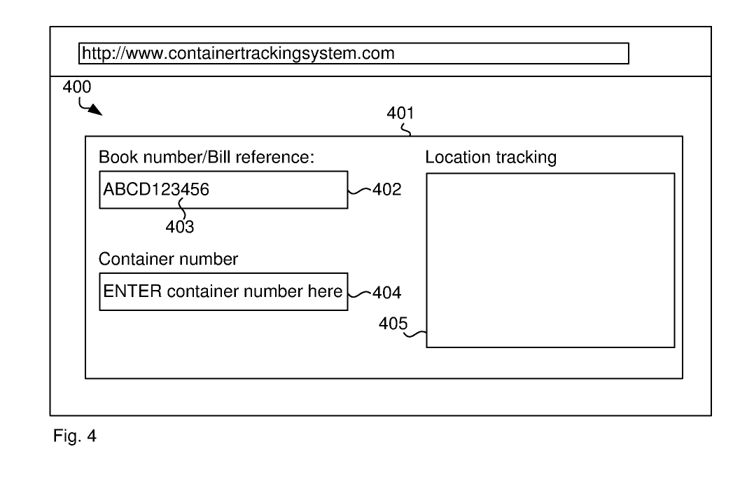

FIG. 4 illustrates a user interface 400 for a logistics system such as container tracking system 200. For example, user interface 400 may be generated by a cloud-based webserver 200 by creating code and sending the code to a client computer system. The code may comprise HTML elements as well as javascript elements and references to media items, such as images and videos. A user may view and interact with the user interface 400 through a browser software application, which interprets the received code and renders the interface 400 on a computer screen of freight forwarder computer system 211 (the below description equally applies to computer system 212).

The user interface 400 comprises a console 401 displayed on the computer display. The user interface 400 further comprises a background of the computer system 211 in which processes, such as Linux or Windows processes, occur so that information is displayed on the console 401. Console 401 includes a first field 402 in which a book number or bill reference 403 is displayed, that is, first field 402 acts as a book number or bill reference field. Console 400 is configured so that it initially includes no container number in a container number field 404 unless it is entered by the user.

In the background, that is, on a processor of computer system 211, runs a process which determines a container number associated with the book number or bill reference 403. When the console 401 is configured to retrieve the container number by an allowance of the container number 403 on the console, the process populates the container number in the container number field 404. When the container number populates the container number field 404, the console further shows container tracking data including location tracking of the container over time in a location tracking field 405. Freight forwarder computer system 211 communicates with container tracking system 200 to perform method 300 in FIG. 3 to determine the container number for container number field 404 and the container tracking data for container tracking data field 405.

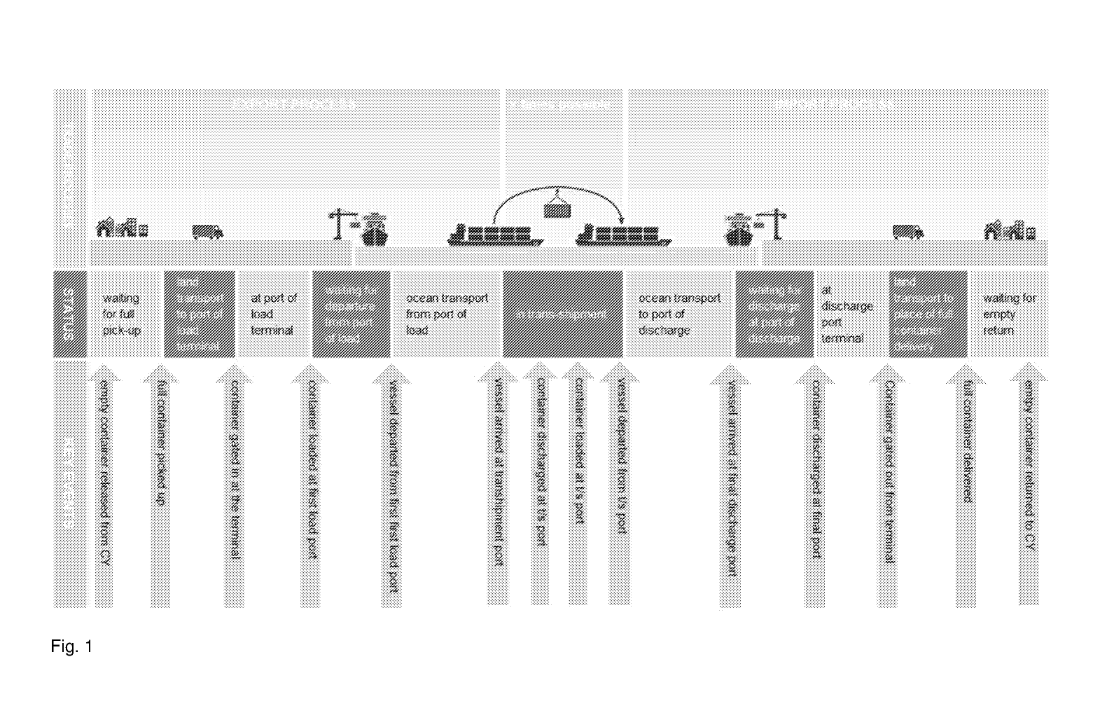

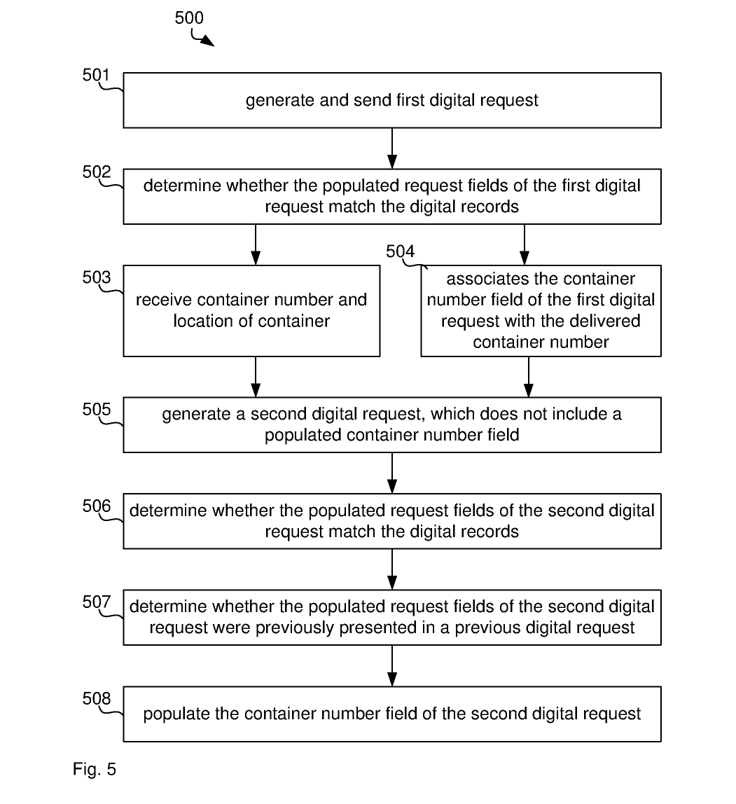

FIG. 5 illustrates a method 500 for logistics management as performed in cargo container tracking system 200. A cargo container is delivered and received via a transit path as shown in FIG. 1. The cargo container is received and delivered by a particular cargo carrier 210 identifiable by a carrier code. The cargo carrier 210 maintains digital records of the cargo container of at least one of:

a carrier code with the carrier booking reference,

a carrier code with a master bill reference, and

a carrier code and a container number.

Method 500 commences by generating 501 a first digital request for the whereabouts of a container. The first digital request for the whereabouts of a container is transmitted in a specified data format, such as XML or JSON, with four request fields. At least two of the four request fields are populated. Populated in this context means that values are entered in these fields. In one example, if the values are available, they are populated and if the values are not available, the fields remain empty, that is, unpopulated. The four request fields comprise:
a carrier code field,
the carrier booking reference field,
master bill reference field, and
a container number field having places for one or more containers.

Processor 200 then determines 502 whether the populated request fields of the first digital request match the digital records of the cargo carrier. This may be achieved by sending the populated request fields to the carrier 210 or by directly querying the carrier database. Matching may refer to all field values being identical or at least one field value being identical. If the populated request fields do match the digital records of the cargo carrier, processor 200 receives 503 as per the first digital request, the container number and the location of the container as described above. Conversely, if the container number was not part of the first digital request, processor 200 associates 504 the container number field of the first digital request with the delivered container number and stores the same as a record in database 207 as described above.

Next, processor 200 generates 505 a second digital request, which does not include a populated container number field and determines 506 whether the populated request fields of the second digital request match the digital records of the cargo carrier. If the populated request fields do not match the digital records of the cargo carrier, processor 202 determines 507 whether the populated request fields of the second digital request were previously presented in a previous digital request. If a previous digital request included at least one populated request field of the second digital request and a container number has been associated with the previous digital request, processor populates 508 the container number field of the second digital request.

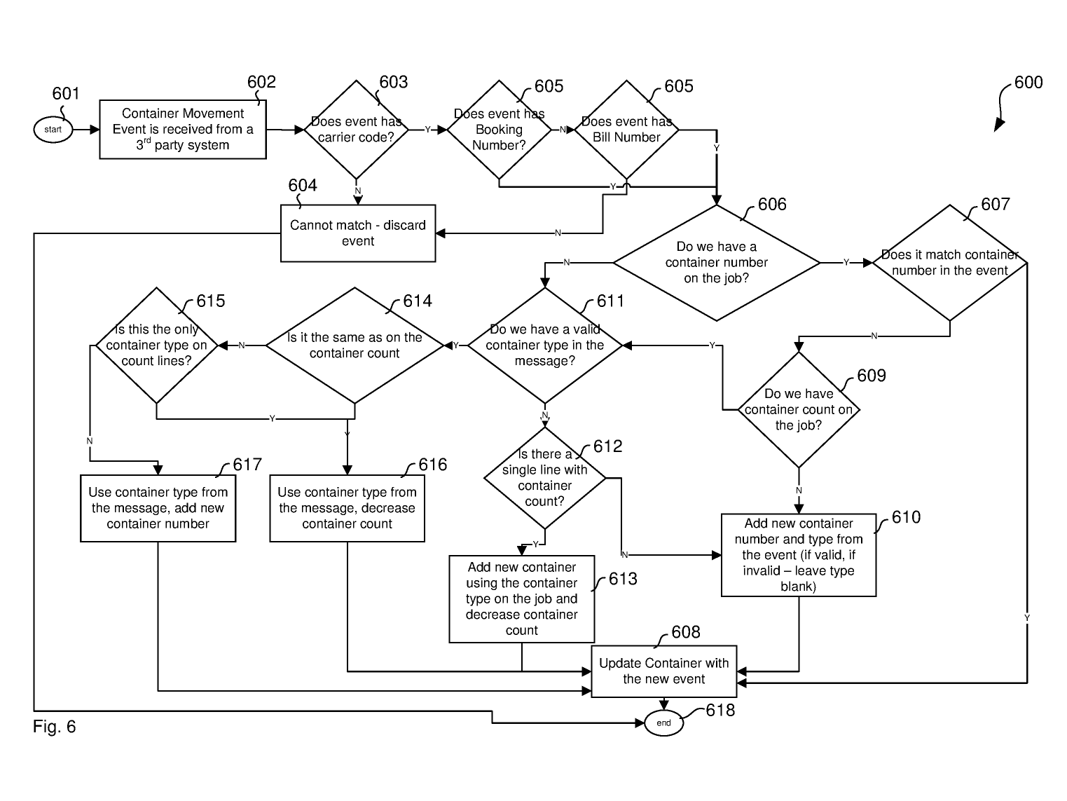

FIG. 6 illustrates a more detailed control flow as performed by processor 202 of container tracking system 200. Processor 202 remains at the start point 601 until it receives 602 a container movement event from a third party system, such as container carrier computer system 210. Processor 202 checks 603 whether the event has a carrier code. If the event does not have a carrier code, processor 202 discards 604 the event. If the event does have a carrier code, processor checks 605 whether the event has a booking number. If the event does not have a booking number, processor 202 checks 606 whether the event has a bill number. If the event has no booking number and no bill number, processor 202 discards 604 the event. If the event has either a booking number, a bill number of both, processor 202 checks 606 whether there is a container number on the job identified by the booking number or the bill number or both. If there is a container number, processor 202 checks 607 whether the container number on the job matches the container number in the event and if it does, processor 202 updates 608 the container with the new event. If the job container number and event container number do not match, processor 202 checks 609 whether there is a container count on the job. If there is no container count on the job, processor 202 adds 610 a new container number. If the type from the event is valid, processor 202 also adds the type and if not, processor 202 leaves the type blank. Processor 202 can then update 608 the container with the new event.

Returning back to checks 606 and 609, if there is no container number on the job (606) but there is a container count on the job (609), processor 202 checks 611 whether there is a valid container type in the message. If there is no valid container type in the message, processor 202 checks 612 whether there is a single line with container count. If there is a single line with container count, processor 202 adds 613 a new container using the container type on the job, decreases the container count and continues with updating 608 the container with the new event. If in check 612 there is not a single line with container count, processor 202 adds 610 a new container number and updates 608 the container with the new event.

Returning back to check 611, if there is a valid container type in the message, processor 202 checks 614 whether it is the same as on the container count. If the container type is not the same as on the container count, processor 202 checks 615 whether this is the only container type on count lines. If the container type is the same as on the container count (614) or the container type is the only container type on the count lines, processor 202 uses 616 the container type from the message, decreases the container count and updates 608 the container with the new event. Conversely, if the container type is not the same as on the container count (614 no) and the container type is not the only container type on count lines (615 no), processor 202 uses 617 the container type from the message, adds the new container number and updates 608 the container with the new event. After processor 202 has discarded the event in step 604 or updated the container in step 608, processor 202 reaches the end state 618.

If there is a container count on the job or if there is no container number on the job in step 606, processor 202 checks 610 whether there is a valid container type in the message.

The instant description illustrates how containers are matched to a booking/consol, new container numbers added and container counts automatically adjusted. A consignment registration module can prompt a user, such as freight forwarders, shippers, freight consolidators or agents handling the goods to be shipped, to enter information about the type and quantity of goods that are being shipped, names and addresses of supply chain stakeholders, etc.

A consignment routing module can prompt a user, such as the shippers, carriers, and freight forwarders handling the goods to be shipped, to enter information about the destination for the goods and any other information about the shipping pathway from the intake point for the goods to the final destination. An electronic data exchange facility module can prompt a user, such as carriers and freight forwarders handling the goods along the path to next in the supply chain stakeholder, to enter information and confirm that a transfer of the goods was done under secure conditions and no suspicion of tampering occurred. The electronic data exchange module can also be a supply chain security module that verifies the security of the goods at each point along the supply/shipping chain.

As mentioned above, database 207 or portions of database 207 can be stored locally to the system 200, such as on a server, stored remotely and accessed across a network or stored in a cloud-based computing system. The use of a cloud-based computing system and/or remote storage of the database on a network system allows multiple users to access the relevant information stored on the database.

In an embodiment of the system, a system vendor can maintain and update the system database as a value added service to system freight forwarders. Selected portions of the information on the database can be restricted to selected freight forwarders, i.e. only freight forwarders requiring or requesting access to the information. Alternatively, the database can be open, allowing all the users and/or freight forwarders access to any of the information of the database. Privacy concerns may lead to the redaction or restriction of information, or portions thereof, to predetermined or preselected users.

Further, as described above database 207 can be updated with information from a larger freight and logistics system 210. The information can be pushed from the larger system 210 or pulled from the larger system 210 by a security system. Alternatively, if the systems are integrated, database 207 can be a shared database that stores the container tracking data and can be accessed and updated by both systems.

One advantage of the disclosed methods and systems is that previously a freight forwarder needed a container number in order to get container tracking information. The disclosed methods and systems can track containers by other job references: booking number, bill number, container number (all with carrier code). When container movement events start flooding system 200, processor 202 finds
1) parent job for this container;
2) identify if the container on the movement is the same container as on the job;
3) update the container with an event, or create a container and update it with an event, or discard the event.

Where the container ongoing data feed process is described it is noted that this is applicable to a single freight forwarder subscribing to multiple container events data providers. Tracking system 200 provides deeply integrated near real-time container and associated vessel tracking, based on information received from major ocean carriers worldwide as well as land-based and satellite automatic identification system (AIS) technology. This functionality is in the process of being extended to support data feed from various international ports and also to other transport modes.

A freight forwarder can register a consol or a declaration in the system as the freight forwarder would normally do, and every ocean booking, master bill and container managed within tracking system 200 will be automatically updated with latest ocean container statuses inland and at sea. No more manual carrier web site searching or phone calls, no more manual data entry and extra time and errors associated with it, prevent missing events and penalties, keep freight forwarders up-to-date with fully automated alerts or WebTracker visibility.

Key events that may be included in the container tracking data may include

empty container released from CY,

full container picked up,

container loaded at first load port,

vessel arrived at transshipment port

container discharged at t/s port,

container loaded at t/s port,

vessel departed from t/s port

(items d)-g) may be repeated multiple times)

vessel arrived at final discharge port,

container discharged at final port

container gated out from terminal

full container delivered,

empty container returned to CY.

An ocean booking, master bill and container managed within tracking system 200 can be automatically submitted to receive all latest statuses and location updates for the active containers and shipments registered in system 200 from the moment of ongoing data feed request to auto-termination, i.e. tracking of a certain container automatically terminates after a dehire date is provided or a carrier advises that the shipment has been terminated.

Key container movement events and status updates received by processor 202 in step 303 may contain date and time information (including change of estimated dates) and are automatically added to containers and cascaded and propagated to related jobs (consols, declarations, shipments, schedules), firing milestones and trigger actions according to setup preferences and also automatically updating dates associated with container events on operational jobs.

Workflow tracking events or milestones can be exposed on a web tracker application enabling freight forwarders to self-track their shipments and containers. Workflow milestones and triggers can be configured to forward useful tracking events to freight forwarders or agents, or alert staff of any exceptions or missed dates (for example, when a container is held or not on schedule), so that staff can quickly response and resolve issues with terminals, carriers or transport providers. This means users don't waste time sourcing container movements and statuses elsewhere or entering the data manually into the system, increasing productivity, accuracy and enabling pro-active resolution of potential problems.

Integration may be provided with major ocean carriers and vessel tracking AIS technology and can be further extended to other carriers and transport modes. Container carriers may include terminals and processor 202 may receive directly from major terminals worldwide container tracking data in the form of terminal events. There are other domestic and global providers and carriers capable of providing container tracking information, and the data from these providers can extend the tracking with comprehensive ongoing data feed tools to ensure that the events received are the most accurate and non-repetitive.

In one example, carrier SCAC number is entered in the dedicated field on the carrier organization and there is no need to manually append SCAC code to a Bill of Lading number. Including a SCAC code in addition to the bill number (also referred to as master bill reference) provided by a carrier, may cause mismatching on the carrier site and prevent freight forwarders from container tracking by Bill Numbers.

In one example, processor 202 automatically sends an ongoing data feed request to a tracking server for each sea consol or declaration where a carrier has the SCAC code recorded. The ongoing data feed request is sent for carrier booking reference, master bill and each container number. For co-load consols the ongoing data feed may only occur by container number and BOL number. Processor 202 may then source container movement events from various sources and ocean carriers depending on their preferences (by booking, bill or container number or a combination of thereof). Processor 202 receives, maps, processes, de-duplicates and normalizes container tracking data, such as movement events, received from various sources before passing them to freight forwarder computer system 212 in a form of Universal Event XML.

It is not a requirement to submit a carrier booking or a shipping instruction in order to receive ocean container tracking events. It is sufficient to simply register a consol or declaration in freight forwarder system 211 or 212 with a carrier that has a SCAC code and either a booking, BOL number or container numbers.

Regardless of a number of ongoing data feeds on a single job, the container count for billing purposes may apply only when the first successful event is received back to freight forwarder system 211 or 212. I.e. an invalid booking number or unsupported carrier code may not cause tracking events generated and may not be charged for.

Once the automatic ongoing data feed request is sent upon registration of a Booking number, BOL number of each of the container numbers, the SBR—Subscription (named for the ongoing data feed) Requested event is added to the consol (or a container for container level ongoing data feed). Container Tracking may track not just containers which numbers where previously registered on a consol, but also will automatically add container numbers as advised by ocean carriers against a booking or bill reference provided by freight forwarder computer systems 211 and 212, minimizing the need for data entry.

Since events are tracked by an ocean carrier, the ongoing data feed may change if a carrier organization on the consol or stand-alone declaration is changed. In this case any earlier ongoing data feeds may become obsolete, and new ongoing data feed events may be generated for each booking, bill and container number. A new ongoing data feed event may be created if either a booking reference number or a bill number are changed. Any new container added, or a change of a container number may also create a new ongoing data feed event.

Each unique ongoing data feed request is maintained by tracking system 200, and the same container on the same job with the same carrier may not be subscribed, counted or charged for twice. Once subscribed to container tracking, the container tracking events are sent back to the tracking system 200, which processes the information and updates consols and containers with the relevant information.

Upon processing of successful ongoing data feed request, an acknowledgement event may be generated: IRA—Interchange Receipt Acknowledged. This event indicates that the ongoing data feed details are correct and a freight forwarder may expect tracking events and statuses to start coming soon. At times when a container tracking ongoing data feed is not successful (for example, invalid carrier SCAC code, or tracking information is not yet available from a chosen carrier, or an invalid booking number, etc), processor 202 may send unsuccessful ongoing data feed alert, allowing the freight forwarder to take further action if required. The IRJ—Interchange Rejected event with the reason of “Invalid Subscription Data” may be added to the events log.

If container numbers were not known at a time of ongoing data feed request by a Booking Number (or even by a Bill Number), the actual container numbers will be sent back to freight forwarder computer system 211 and 212 together with these container tracking events. For example, if a booking was registered for 2×20GP containers, the automatic ongoing data feed request by booking reference number may return an empty yard gate out/export release event together with the actual container number.

These container numbers and types (where types are advised by carriers) can be automatically added to consolidations together with corresponding container movement events and in some cases with carrier and customs statuses events. In addition, the receipt of a previously unknown container number may also generate the CID—Change of Identifier event in the following format:

Optional Text\TYP=value1\OLD=value2\NEW=value3\RES=value4

For example, \TYP=Container\New=CLRU21938948 \RES=container number advised,

which can be interpreted by Event Details as:

Container Change of Identifier to CLRU21938948 because container number advised.

If a consolidation had a container count, and an actual container number has been received with a matching type or no type, the container count is decreased by one, and the container number is added with the corresponding events (CID and, for example, GOU event). If it is not possible to match a container number received against the registered container counts and their types, the new container is added to the consol with corresponding events, and an operator can verify the type and counts of the remaining containers.

Events and status updates received by the tracking system 200 are mapped to a standard Universal Event XML supporting event parameters. The following table illustrates how tracking events and statuses correspond to events and which fields they automatically update.

When an event received by the container tracking system 200 cannot be mapped to a key event in database 204 that updates fields on containers, consols and routing legs, it is mapped to the STU—Status Updated event which, while not updating any fields, will be clearly visible in the event log for the benefit of your freight forwarders and staff.

Below is the list of possible events that can be processed.

Note: Events received by tracking system 200 may be sourced from carriers, third party systems, terminals, vessel satellite tracking systems.

The list and quantity of events varies from carrier to carrier. While some carriers provide very comprehensive tracking, other carriers only support a basic set of events.

Processor 202 may continuously communicate with carriers, terminals and integrators to make the list of tracking events as comprehensive as possible. The diagram in FIG. 1 illustrates typical process of a container “lifecycle” with arrows indicating key events and statuses between these events. From a moment of ongoing data feed request, events sourced from this point onwards can be submitted to freight forwarder system 211 or 212 and may update containers, consols and routing legs with the actual dates and corresponding milestones.

If land transport service is not provided by an ocean carriers, full pickup and full delivery events can be excluded from ocean carrier tracking (but can be sourced from integrated transport systems). When it is possible to calculate the current status of a container from an earlier event, the STU—status updated event will be added for clarity as illustrated below.

| | | | Corresponding Event Name | |
|---|---|---|---|---|
| | | Event | and Event Reference | Field updated by this |
| Key Events | Statuses | Code | Parameters | event |
| empty | | GOU | Gate Out | Consol > Containers > |
| container | | | Parameters: | Export Process > Empty |
| released from | | | \|FAC = CY\|LOC = UNLOCO | released |
| container | | | Event Details: | |
| yard | | | Gate Out at Container Yard | |
| | | | location | |
| | waiting | STU | Parameters: | |
| | for full | | \|DEP = Carrier\|TYP = waiting for | |
| | pickup | | pickup | |
| | | | Event Details: | |
| | | | Status Updated by Carrier: | |
| | | | waiting for pickup | |
| full container | | PUP | Picked up | Consol > Containers > |
| picked up | | | Parameters: \|TYP = FUL | Export Process > Actual |
| | | | Event Details: | Full Pickup date |
| | | | Full Picked up | |
| | land | STU | Parameters: | |
| | transport | | \|DEP = Carrier\|TYP = land | |
| | to | | transport to POL | |
| | port of | | Event Details: | |
| | load | | Status Updated by Carrier: | |
| | terminal | | land transport to POL | |
| container | | GIN | Gate In | Consol > Containers > |
| gate in at the | | | Parameters: | Export Process > FCL |
| load port | | | \|FAC = CTO\|LOC = UNLOCO | Wharf Gate In, |
| terminal | | | Event Details: | |
| | | | Gate In at Terminal location | |
| | at port | STU | Parameters: | |
| | of load | | \|DEP = Carrier\|TYP = in POL | |
| | terminal | | terminal | |
| | | | Event Details: | |
| | | | Status Updated by Carrier: in | |
| | | | POL terminal | |
| container | | FLO | Freight Loaded | Consol > Containers > |
| loaded on | | | Parameters: | Export Process > FCL |
| board (first | | | \|FAC = CTO\|LOC = UNLOCO | Loaded, |
| load port or | | | Event Details: | when UNLOCO |
| transshipment) | | | Freight Loaded at Terminal | corresponds to the first |
| | | | location. | consol's first leg's load |
| | | | This could be First Port of | port, otherwise this event |
| | | | Loading or Transshipment Port | will just be added to the |
| | | | of Loading | log |
| | waiting | STU | Parameters: | |
| | for | | \|DEP = Carrier\|TYP = waiting for | |
| | departure | | departure from POL | |
| | from | | Event Details: | |
| | port of | | Status Updated by Carrier: | |
| | load | | waiting for departure from | |
| | | | POL | |
| vessel | | DEP | Departure | The system automatically |
| departed | | | Parameters: Departed | updates ATD of the |
| (first load | | | \|FAC = CTO\|LOC = UNLOCO | corresponding routing |
| port or | | | Departure Terminal location | leg and linked sailing |
| transshipment) | | | This could be First Port of | schedule |
| | | | Load or a Transshipment Port | |
| | ocean | STU | Parameters: | |
| | transport | | \|DEP = Carrier\|TYP = ocean | |
| | from | | transport from POL | |
| | port of | | Event Details: | |
| | load | | Status Updated by Carrier: | |
| | | | ocean transport from POL | |
| | in | STU | Parameters: | |
| | transshipment | | \|DEP = Carrier\|TYP = in | |
| | | | transshipment | |
| | | | Event Details: | |
| | | | Status Updated by Carrier: in | |
| | | | transshipment | |
| | ocean | STU | Parameters: | |
| | transport | | \|DEP = Carrier\|TYP = ocean | |
| | to | | transport to POD | |
| | port of | | Event Details: | |
| | discharge | | Status Updated by Carrier: | |
| | | | ocean transport to POD | |
| vessel arrived | | ARV | Arrival | The system automatically |
| (transshipment | | | Parameters: Arrived | updates ATD of the |
| or last | | | \|FAC = CTO\|LOC = UNLOCO | corresponding routing |
| discharge | | | This could be Final Port of | leg and linked sailing |
| port) | | | Discharge or Transshipment | schedule |
| | | | Port of Discharge | |
| | waiting | STU | Parameters: | |
| | for | | \|DEP = Carrier\|TYP = waiting for | |
| | discharge | | discharge at POD | |
| | at | | Event Details: | |
| | port of | | Status Updated by Carrier: | |
| | discharge | | waiting for discharge at POD | |
| container | | FUL | Freight Unloaded | Consol > Containers > |
| discharged | | | Parameters: | Import Process > FCL |
| from vessel | | | \|FAC = CTO\|LOC = UNLOCO | Unload, |
| (final | | | Event Details: | when UNLOCO |
| discharge | | | Freight Unloaded at Terminal | corresponds to the last |
| port or | | | location. | consol's last leg's |
| transshipment) | | | This could be Final Port of | discharge port, otherwise |
| | | | Discharge or Transshipment | this event will just be |
| | | | Port of Discharge | added to the log |
| | at | STU | Parameters: | |
| | discharge | | \|DEP = Carrier\|TYP = in POD | |
| | port | | terminal | |
| | terminal | | Event Details: | |
| | | | Status Updated by Carrier: in | |
| | | | POD terminal | |
| container | | GOU | Gate Out | Consol > Containers > |
| gated out | | | Parameters: | Import Process:> Wharf |
| from port of | | | \|FAC = CTO\|LOC = UNLOCO | Gate Out, |
| discharge | | | Event Details: | when UNLOCO |
| terminal | | | Gate Out at Terminal location | corresponds to the last |
| | | | | consol's last leg's |
| | | | | discharge port, otherwise |
| | | | | this event will be just |
| | | | | added to the log |
| | land | STU | Parameters: | |
| | transport | | \|DEP = Carrier\|TYP = land | |
| | to | | transport to Place of Delivery | |
| | place | | Event Details: | |
| | of full | | Status Updated by Carrier: | |
| | container | | land transport to Place of | |
| | delivery | | Delivery | |
| full container | | DLV | Delivered | Consol > Containers > |
| delivered | | | Parameters: \|TYP = FUL | Import Process > Port |
| | | | Event Details: | Trn. Complete (which |
| | | | Full Delivered | later will be renamed to |
| | | | | Delivered): |
| | waiting | STU | Parameters: | |
| | for | | \|DEP = Carrier\|TYP = delivered; | |
| | empty | | returning container | |
| | return | | Event Details: | |
| | | | Status Updated by Carrier: | |
| | | | delivered; returning container | |
| empty | | DHR | Dehire | Consol > Containers > |
| container | | | Parameters: [optional | Import Process:>Empty |
| returned | | | \|FAC = CY\|LOC = UNLOCO | Returned On |
| | | | Event Details: | (which triggers GIN with |
| | | | Equipment Dehired at | FAC = CY—gate in to |
| | | | Container Yard location | container yard event) |
| | Completed | STU | Parameters: | |
| | | | \|DEP = Carrier\|TYP = completed | |
| | | | Event Details: | |
| | | | Status Updated by Carrier: | |
| | | | completed | |

Additional Vessel Pre-Arrival Advice Statuses

These statuses are received by when vessel is detected near a port of discharge and can assist with planning of POD activities:

| | | CW1 Event | Corresponding CW1 Event Name |
|---|---|---|---|
| Status | Trigger Point | Code | and Event Reference Parameters |
| vessel | Triggered if vessel | STU | Parameters: |
| approaching | will call at POD | | 6 hours to ETA |
| port of | within 6 hours, | | \|MST = Pre-Arrival |
| discharge | based on ETA | | Advice\|TYP = vessel approaching |
| (time) | | | POD\|LOC = UNLOCO |
| | | | Event Details: |
| | | | Status Updated from Pre-Arrival |
| | | | Advice: vessel approaching POD |
| | | | Sydney, AU, 6 hours to ETA |
| vessel entered | Triggered if vessel | STU | Parameters: |
| port of | has been detected | | \|MST = Pre-Arrival |
| discharge | within area of | | Advice\|TYP = vessel entered POD |
| | POD | | Event Details: |
| | | | Status Updated from Pre-Arrival |
| | | | Advice: vessel entered POD Sydney, |
| | | | AU |
| vessel moored | Triggered if vessel | STU | Parameters: |
| in POD | has been detected | | \|MST = Pre-Arrival |
| | within area of | | Advice\|TYP = vessel moored in POD |
| | POD and vessel | | Event Details: |
| | has moored for the | | Status Updated from Pre-Arrival |
| | first time | | Advice: vessel moored POD Sydney, |
| | | | AU |
| vessel | Triggered if vessel | STU | Parameters: |
| approaching | distance to POD is | | 6 hours to ETA |
| port of | less than 100 nm | | \|MST = Pre-Arrival |
| discharge | | | Advice\|TYP = vessel approaching |
| (distance) | | | POD |
| | | | Event Details: |
| | | | Status Updated from Pre-Arrival |
| | | | Advice: vessel approaching POD |
| | | | Sydney, AU, less than 100 nm |

Estimated Events

It is possible to receive estimated date changes for each of the key events above. For example, if ETA changes, the ARV event will be received with the “Estimated” flag (and will be accompanied by the EST). The corresponding dates are updated for events received electronically. Note, change of estimated arrival can be advised in advance, or while a vessel is already approaching port of discharge.

Global Container Tracking ongoing data feed process as described above processes container tracking events from various sources, maps them to Universal Events XML that are received by tracking system 200 upon automatic ongoing data feed request to container tracking.

Container matching to relevant consolidations:

The container events received are matched against a carrier SCAC, carrier booking reference and BOL number registered on consolidation. This is the order for matching: If Carrier SCAC, Carrier Booking Reference and Bill of Lading number all present in the message, all three values are matched to identify a consol with matching carrier, booking reference and bill number.

If only Carrier SCAC and Carrier Booking Reference are present in the message, processor 202 uses both, SCAC and booking reference, to find a consol with matching values of SCAC and booking reference.

If only Carrier SCAC and Master Bill of Lading are available in the message, the consol with matching SCAC and Master Bill will be updated accordingly.

If a container tracking event is received via the Global Container Tracking service, and this container number is not on the consol, the container number will be added to the consol and the tracking event will be added to this container, as well as all following container tracking events.

Container Number add/replace rules:

If a container number in the message matches the container number on a consol, the container tracking event will be added to the existing container. The container number in the message will replace container information on a consol, if there is only one container on this consol (container count is one) and the container number is blank.

If Container Type (i.e. container quality) is received in the message and it matches the Container Type on the consol, this type will be used. For example: consol 1×20GP; message container NNN, type 20GP; outcome: NNN 20GP. If Container Type is blank in the message, the Container Type previously entered by the user is used as a container type for the newly created container; For example: consol 1×20GP; message container NNN, type blank; outcome: NNN 20GP If Container Type is received in the message, but it does not match the Container Type on the consol: If the Container Type received in the message is a valid container type, this type is used instead of the type originally registered on the consol. For example: consol 1×20GP; message container NNN, type 40GP; outcome: NNN 40GP.

If the container type received in the message is not a valid container type, the type registered on the consol is used against a container number from the message. For example: consol 1×20GP; message container NNN, type 1234; outcome: NNN 20GP In this scenario the container number replaces the container count line, and container tracking events will be added to this container. A container number received in the message will be added as a new container record to the consol, when:

No container numbers exist on the consol and no lines with container count exists on the consol. For example: consol—no containers; message container NNN, type 20GP; outcome: NNN 20GP. consol—no containers; message container NNN, type blank; outcome: NNN blank type.

None of the container numbers on the consol matches the number in the message, AND There are no container count lines. For example: consol container ZZZ 20GP; message container NNN, type 20GP; outcome: container NNN 20GP added to the existing ZZZ 20GP OR There are container count lines but none of the types of the container counts matches the type in the message For example: consol container ZZZ 20GP, 2×20GP, 1×40 GP; message container NNN, type 20RE; outcome: container NNN 20RE added to the existing containers and container count lines.

A container number received in the message will be added as a new container record to the consol and reduce container count, when: Container count is more than one, and type in the message matches one of the types of container count records;

For example: consol 3×20GP; message container NNN, type 20GP; outcome: NNN and 2×20GP Container count is more than one, and type in the message is blank or invalid, but this is the only container count line on the consol For example: consol 3×20GP; message container NNN, blank type; outcome: NNN and 2×20GP.

If ISO code is in the message, tracking system 200 uses ISO code in Universal Event XML. If no ISO and the “type” is in the message—processor 202 can map it on eHub to ISO. If we can't map, we send ISO blank in Universal Event XML. And then the rules above apply. Mainly: if there is only one container—may always update it. If ISO is in the message—use this ISO, if not—use the container type entered by the user.

The disclosed methods and systems include correlating shipment identifiers to create a record in a database so that an ongoing data feed may be delivered pertaining to the same container. While the above disclosure refers to sea container tracking, the same systems and methods as those disclosed can be carried out with tracking cargo by Master Air Waybill numbers (and may extend to road and rail cargo carriers). The term used throughout the present disclosure, “carrier” can pertain to any carrier, including for example, ocean freight, air freight carrier and land carriers. The identifier properties for different transit types may be different, however, creating the record in the database to provide the ongoing data feed may be the same.

In air freight the identifier is a Master Air Waybill. Master Air Waybill consists of prefix and suffix, where prefix points to an airline (the air carrier) from which tracking details are obtained. In air freight, the cargo is mostly shipped loose, thus making MAWB a key freight identifier. Master Air Waybill (MAWB) is unique for about one year, before airlines can recycle it. Instead of the carrier code and three possible criteria for sea freight (Container Number, Master Bill Number and Booking Number) for air freight, a recording in a database is created by tracking and correlating records of a MAWB.

If cargo is split across multiple flights, the same MAWB number remains on parts of cargo. Therefore, the whole MAWB and parts of thereof can be tracked if it was split. In case of split there will be many more events than in sea freight. A single query to the carrier can thus provide an ongoing data feed related to many such events. Accordingly, minimising query traffic between the carrier and freight forwarders can provide a productive solution.

A third party system (such as an integrator) or any supply chain party in a possession of a container that can report tracking details (e.g. container yard, terminal, port) are included in the definition of carrier. According to the disclosed systems and methods, a computer system may query any party's system having container or event data to minimize query traffic to that party. Also customs brokers, packing facilities, land transport providers etc. may be want to track containers creating additional traffic to a carrier system. Any party's system may be a first freight forwarder computer system and the second freight forwarder computer system.

The data set stored on database 207 may be further enhanced by reaching out to more ocean carriers, data providers, container yards, container terminals and AIS data providers.

The success rate of data matching may be further enhanced by building a database of related ports (when there are several port codes near the same location, for example Los Angeles has codes for port of LA, USLAX, and Long Beach, USLGB, etc.), so that processor 202 can return to customers container tracking events and update relevant fields in their local databases based on events occurred in the locations near the port. This is an advantage over other approaches where if the port on a job was registered as USLGB, but an event received in USLAX processor 202 would not update the field. With this enhancement processor 202 now updates the field).

Also, processor 202 updates fields based on related ports only if we know that vessels scheduled in one of these related ports (i.e. processor 202 also checks vessel schedule). If the vessel calls all of the related ports—processor 202 may not update fields because processor 202 expects container movement events in a specific location. For example, if tracking data indicates that the vessel only calls USLAX, but customer has entered the port as USLGB, processor 202 updates the field. On the other hand, if the tracking data indicates that the vessel calls both, USLAX and USLGB, and the customer has registered USLGB, even if processor 202 receives a container move for USLAX—processor 202 will pass this event to the customer for information, but we will not update the field in the system because processor 202 expects container movement event in USLGB.

Processor 202 may further build a database of preferred data providers. Preferred data providers are those who can provide events more timely and/or accurately than other data providers. When processor 202 can source a container event from multiple sources—for example obtaining an event from a data provider or from a carrier directly, processor 202 will give preference to the carrier data. If a time of commencement of tracking preferred data provider events cannot be sourced (e.g. preferred data provider may only provide container movements based on container numbers, but at a time of a booking a container number is not known), processor 202 will subscribe to 2nd preferred provider to start obtaining relevant information (that processor 202 uses to update database 207 and also pass to the customers). Based on this information, processor 202 starts sourcing events from the most preferred provider taking their events as preferred.

Processor 202 may further calculate preferred data providers based on carrier and locations of the jobs. For example, in Australia processor 202 can receive container movement events directly from container terminals in real time, while in other countries this service may not be available. So if processor 202 identifies from subscription the location of the job (departure port/country and arrival port/country) and the stored data indicates that there is a data provider specific to one of the locations, processor 202 subscribes to this provider to get events pertaining to this location in preference to other providers, and at the same time keep sourcing data from other providers to cover other locations of container journey. For example, a container is linked to a job from Germany to Australia, processor 202 subscribes to Australian terminals, but also to other providers. So all container movements for Germany and all countries where container could be transitted or transhipped through are received from ‘other’ sources, while all Australian container moves are sourced from Australian terminals, because their date is very accurate and very timely.

Processor 202 may also automatically advise customers if their containers cannot be tracked for certain reasons, so that they can proactively manage their tracking. For example, a customer may enter a booking number “TBA”. In this case, processor 202 could try to subscribe by this “number” and after numerous attempts send a rejection event to the customer. Instead, processor 202 may not subscribe in the first place and ask customer to fix their data. Also if an ocean carrier code is incorrect or missing—processor 202 can automatically alert the customer in advance to either fix the code or do not expect container movement messages.

In one example, the methods above are implemented in a container tracking module, which is then integrated into a carrier booking module. This allows customers to make bookings with ocean carriers electronically. Once the booking is made processor 202 receives cargo tracking events from some of the carriers. This means, the “booking” mechanism is not just used as a booking but also as one of the methods of subscription for container tracking, so that container movement and cargo status events received from carriers as a reply to booking, can update the container tracking database 207 and be distributed to all interested customers.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A container tracking system for communicating container tracking data over a data network, the data network comprising the container tracking system, a container carrier computer system, a first freight forwarder computer and a second freight forwarder computer, the container tracking system comprising:
a database server;
an input port to receive electronic tracking request data from the first freight forwarder computer system and the second freight forwarder computer system and to receive container tracking data from a container carrier computer;
an output port to send container tracking data to the first freight forwarder computer system and the second freight forwarder computer system; and
a processor configured to:
a. receive from the first freight forwarder computer system via the input port first electronic tracking request data for container data stored at the carrier computer, the first electronic tracking request data being representative of a first shipment identifier being of a shipment identifier type that is different to a container identifier type;
b. send the first electronic tracking request data to the container carrier computer system;
c. receive from the container carrier computer system via the input port first response data, the first response data being indicative of a first container identifier being of a container identifier type and first container tracking data;
d. create a record in a database of the container tracking system comprising the first shipment identifier associated with the first container identifier and associated with the first container tracking data;
e. repeat steps a, b, c and d to create multiple records in the database of the container tracking system comprising multiple shipment identifiers associated with multiple container identifiers and associated with further container tracking data;
f. receive from the second freight forwarder computer system via the input port second electronic tracking request data, the second electronic tracking request data being representative of a second container identifier or a second shipment identifier;
g. query the database to retrieve a selected record by matching the second container identifier against the multiple container identifiers in the database or by matching the second shipment identifier against the multiple shipment identifiers in the database, wherein the second electronic tracking request data remains outside the container carrier computer system; and
h. send via the output port the selected record as a response to the second electronic tracking request data to the second freight forwarder computer system.

2. The container tracking system of claim 1, wherein to send the first electronic tracking request data comprises to generate a database query to determine a shipment provider computer system that offers access to container tracking data based on the received shipment identifier type to send the electronic data request message to the determined container carrier computer system.

3. The container tracking system of claim 1, wherein the first response data is indicative of multiple container identifiers associated with the first shipment identifier and the processor is configured to create a record in the database for each of the multiple container identifiers.

4. The container tracking system of claim 1, wherein the processor is further configured to:
receive tracking data via multiple data feeds;
discard part of the tracking data for container identifiers that are not in the database;
associate the multiple container identifiers with the shipment identifiers to continuously create or update records in the database to store the continuous container tracking data;
transmit the updated records to the first freight forwarder computer system and second freight forwarder computer system.

5. The container tracking system of claim 1, wherein the second shipment identifier is of a different shipment identifier type to the first shipment identifier type.

6. The container tracking system of claim 1, wherein the database server stores a port database of related ports, and the processor is configured to repeat steps b., c. and d. for the related ports.

7. The container tracking system of claim 6, wherein the processor repeats steps d. selectively based on vessel tracking data.

8. The container tracking system of claim 1, wherein the database server stores a preferred provider database, and the processor is configured to query the preferred provider database to select a provider and then perform step b. by sending the electronic tracking request data to the selected provider.

9. The container tracking system of claim 8, wherein selecting the provider is based on a location of the provider.

10. The container tracking system of claim 1, wherein the processor is further configured
to generate a user interface to be displayed at the first freight forwarder computer system and second freight forwarder computer system, and
to perform the steps of a. receive the first electronic tracking request data, g. receive the second electronic tracking request data and h. send the selected record through the user interface.

11. A method for communicating container tracking data over a data network, the data network comprising a container tracking system, a container carrier computer system, a first freight forwarder computer and a second freight forwarder computer, the method comprising:
a. receiving from the first freight forwarder computer system via an input port first electronic tracking request data for container data stored at the carrier computer, the first electronic tracking request data being representative of a first shipment identifier being of a shipment identifier type that is different to a container identifier type;
b. sending the first electronic tracking request data to the container carrier computer system;
c. receiving from the container carrier computer system via the input port first response data, the first response data being indicative of a first container identifier being of a container identifier type and first container tracking data;
d. creating a record in a database of the container tracking system comprising the first shipment identifier associated with the first container identifier and associated with the first container tracking data;
e. repeating steps a, b, c and d to create multiple records in the database of the container tracking system comprising multiple shipment identifiers associated with multiple container identifiers and associated with further container tracking data;
f. receiving from the second freight forwarder computer system via the input port second electronic tracking request data, the second electronic tracking request data being representative of a second container identifier or a second shipment identifier;
g. querying the database to retrieve a selected record by matching the second container identifier against the multiple container identifiers in the database or by matching the second shipment identifier against the multiple shipment identifiers in the database, wherein the second electronic tracking request data remains outside the container carrier computer system; and
h. sending via an output port the selected record as a response to the second electronic tracking request data to the second freight forwarder computer system.

12. A non-transitory computer readable medium with software code stored thereon that, when executed by a computer, causes the computer to perform the method of claim 11.

13. (canceled)

14. The container tracking computer system of claim 1, wherein
the electronic tracking request data is indicative of a first number of containers;
the container tracking data is indicative of a second number of containers; and
the computer processor is further configured
to compare the first number of containers to the second number of containers and create an alert if the first number of containers is different to the second number of containers.

15. The container tracking computer system of claim 1, wherein
the electronic tracking request data is indicative of a first quality of containers;
the container tracking data is indicative of a second quality of containers; and
the computer processor is further configured
to compare the first quality of containers to the second quality of containers and create an alert if the first quality of containers is different to the second quality of containers.

16. The container tracking computer system of claim 1, wherein the processor is further configured
to send to the shipment provider computer system an ongoing data feed command to cause the shipment provider computer system to continuously send container tracking data to the container tracking system;
to receive continuous container tracking data from the shipment provider computer system, the continuous container tracking data being indicative of multiple container identifiers associated with the shipment identifier;
to determine which of the multiple container identifiers are missing on the database server; and
to store the container tracking data and the multiple container identifiers that are missing on the database server associated with the shipment identifier.

17. The container tracking computer system of claim 1, wherein
the container tracking data is indicative of a number of containers; and
the computer processor is further configured to initialise a counter with the number of containers and decrement the counter each time the processor receives a container identifier that is missing from the database.

18.-25. (canceled)
